(19) United States
(12) Patent Application Publication
(10) Pub. No.: US 2018/0079834 A1
(43) Pub. Date: Mar. 22, 2018

(54) RUBBER COMPOSITION FOR TIRE TREADS, AND PNEUMATIC TIRE

(71) Applicant: THE YOKOHAMA RUBBER CO., LTD., MINATO-KU, TOKYO (JP)

(72) Inventors: Manabu KATO, HIRATSUKA CITY, KANAGAWA (JP); Ryota TAKAHASHI, HIRATSUKA CITY, KANAGAWA (JP); Takahiro OKAMATSU, HIRATSUKA CITY, KANAGAWA (JP); Yoshiaki KIRINO, HIRATSUKA CITY, KANAGAWA (JP)

(21) Appl. No.: 15/557,998

(22) PCT Filed: Mar. 18, 2016
(86) PCT No.: PCT/JP2016/058697

§ 371 Date: Sep. 13, 2017

(30) Foreign Application Priority Data
Mar. 19, 2015 (JP) 2015-056656

(51) Int. Cl. C08C 19/36; C08C 19/22; C08L 9/06; C08L 15/00; C08K 3/04; C08K 5/29; B60C 1/00

(52) U.S. Cl. CPC C08C 19/36; C08C 19/22; C08L 9/06; B60C 1/0016; C08K 3/04; C08K 5/29; C08L 15/00

(57) ABSTRACT

The present invention provides a rubber composition for tire treads, the rubber composition achieving high rubber hardness and 300% modulus at high temperatures, and excellent dry grip properties when formed into a tire, along with a pneumatic tire obtainable by using the same. The rubber composition for tire treads of the present invention contains carbon black and a diene rubber including a carboxy-modified polymer. The carbon black content is from 80 to 150 parts by mass per 100 parts by mass of the diene rubber. The carboxy-modified polymer is obtained by modifying styrene-butadiene rubber (A) with a nitrone compound having carboxy group (B), and the content of the carboxy-modified polymer in the diene rubber is from 10 to 100 mass %. The content of styrene units in styrene-butadiene rubber (A) is at least 36 mass %. The degree of modification of the carboxy-modified polymer is from 0.02 to 4.0 mol %.

### TECHNICAL FIELD

The present invention relates to a rubber composition for tire treads and a pneumatic tire.

### BACKGROUND ART

Pneumatic tires are comprised of various members, including a tire tread, bead portion, and sidewall portion, with each member comprising the pneumatic tires formed using a rubber composition containing carbon black, rubber components, and the like.

As such a rubber composition, Patent Document 1 describes a rubber composition containing a styrene-butadiene copolymer rubber, carbon black, N,N′-diphenyl-p-phenylenedinitrone (nitrone compound), and the like (see Example 2).

Incidentally, the pneumatic tires described above may be used not only for general vehicles, but also for racing vehicles.

As a rubber composition for tire treads used to form such tires used for racing vehicles (hereinafter, also referred to as “racing tires” or “tires for competition”), Patent Document 2 describes one having 100 parts by weight of two types of solution-polymerized styrene butadiene rubbers with specific properties and from 80 to 150 parts by weight of carbon black with specific properties blended together.

### CITATION LIST

### Patent Literature

Patent Document 1: JP-A-2007-70439

Patent Document 2: JP-B-5088456

### SUMMARY OF INVENTION

### Technical Problems

Racing tires such as those described above are more strictly required to have properties suitable for road surfaces compared to pneumatic tires used for driving general vehicles. For example, when the road surface for a race is dry, racing tires that have grip performance suitable for dry road surfaces (superior in dry grip properties) are used.

Moreover, when racing tires are applied for running on circuits, the rubber comprising the lower part of the tire tread is required to quickly reach a high-temperature state (e.g., from approximately 80 to 120° C.) once the racing vehicle starts to run, in order to exhibit the dry grip performance in a short time.

Therefore, as described in Patent Document 2, rubber compositions used to form the tire tread of racing tires may have a higher blending quantity of carbon black compared to rubber compositions used for the tire tread of general vehicles.

Under these circumstance, when the present inventors examined the rubber composition described in Patent Document 2, it was revealed that while the dry grip properties and rubber hardness thereof at high temperatures were sufficient, the 300% modulus was sometimes insufficient.

The present inventors considered using a styrene-butadiene rubber modified with a nitrone compound (N,N′-diphenyl-p-phenylenedinitrone) like the one described in Patent Document 1, in order to improve the performance of the rubber composition for tire treads having a high carbon black content described in Patent Document 2.

However, rubber compositions obtained sometimes exhibited poor dry grip properties when formed into a tire. The rubber hardness and 300% modulus at high temperatures were sometimes low as well.

Therefore, the object of the present invention is to provide a rubber composition for tire treads, the rubber composition achieving excellent dry grip properties as well as high rubber hardness and 300% modulus at high temperatures when formed into a tire; along with a pneumatic tire obtainable using the same.

### Solution to Problem

The present inventors, upon keenly examining the problem described above, found that by using a carboxy-modified polymer obtained by modifying a styrene-butadiene rubber with a nitrone compound having a carboxy group, superior dry grip properties as well as superior rubber hardness and 300% modulus at high temperatures can be achieved, thereby leading to the present invention.

Specifically, the inventors discovered that the problem described above can be solved by the following features.

[1]

A rubber composition for tire treads containing carbon black and a diene rubber comprising a carboxy-modified polymer, wherein:

the carbon black content is from 80 to 150 parts by mass per 100 parts by mass of the diene rubber;

the carboxy-modified polymer is obtained by modifying styrene-butadiene rubber (A) with a nitrone compound having carboxy group (B), the content of the carboxy-modified polymer in the diene rubber being from 10 to 100 mass %;

the content of styrene units in styrene-butadiene rubber (A) is at least 36 mass %; and

when the degree of modification refers to the proportion (mol %) of double bonds modified with the nitrone compound having carboxy group (B) relative to all double bonds attributed to butadiene in styrene-butadiene rubber (A), the degree of modification of the carboxy-modified polymer is from 0.02 to 4.0 mol %.

[2]

The rubber composition for tire treads according to [1], wherein the nitrone compound having carboxy group (B) is a compound selected from the group consisting of N-phenyl-α-(4-carboxyphenyl)nitrone, N-phenyl-α-(3-carboxyphenyl)nitrone, N-phenyl-α-(2-carboxyphenyl)nitrone, N-(4-carboxyphenyl)-α-phenylnitrone, N-(3-carboxyphenyl)-α-phenylnitrone, and N-(2-carboxyphenyl)-α-phenylnitrone.

[3]

The rubber composition for tire treads according to [1] or [2], wherein the nitrogen adsorption specific surface area of carbon black is from 150 to 400 m²/g.

[4]

The rubber composition for tire treads according to any one of [1] to [3], wherein the amount of nitrone compound having carboxy group (B) used to modify styrene-butadiene rubber (A) is from 0.1 to 10 parts by mass per 100 parts by mass of diene rubber.

[5]

A pneumatic tire comprising a tire tread formed using the rubber composition for tire treads according to any one of [1] to [4].

### Advantageous Effects of Invention

As described below, according to the present invention, a rubber composition for tire treads can be provided which achieves excellent dry grip properties as well as high rubber hardness and 300% modulus at high temperatures when formed into a tire, along with a pneumatic tire obtainable by using the same.

### BRIEF DESCRIPTION OF DRAWINGS

FIG. 1 is a partial cross-sectional schematic view of a tire illustrating one embodiment of a pneumatic tire of the present invention.

### DESCRIPTION OF EMBODIMENTS

The rubber composition for tire treads and the pneumatic tire of the present invention will be described below.

Note that, in the present invention, numerical ranges indicated using “(from) . . . to . . . ” include the former number as the lower limit value and the latter number as the upper limit value.

### Rubber Composition for Tire Treads

The rubber composition for tire treads of the present invention (hereinafter, also referred to as “rubber composition of the present invention”) contains carbon black and a diene rubber including a carboxy-modified polymer.

The carbon black content is from 80 to 150 parts by mass per 100 parts by mass of the diene rubber.

The carboxy-modified polymer is obtained by modifying styrene-butadiene rubber (A) with a nitrone compound having carboxy group (B), wherein the content of the carboxy-modified polymer in the diene rubber is from 10 to 100 mass %.

The content of styrene units in styrene-butadiene rubber (A) is at least 36 mass %.

Moreover, when the degree of modification refers to the proportion (mol %) of double bonds modified with the nitrone compound having carboxy group (B) relative to all double bonds attributed to butadiene in styrene-butadiene rubber (A), the degree of modification of the carboxy-modified polymer is from 0.02 to 4.0 mol %.

Because of such a configuration, the rubber composition of the present invention enables the formation of a tire tread having superior rubber hardness and 300% modulus at high temperatures as well as superior dry grip properties.

The details of the cause for this have not been revealed, but it is presumed that the following is one of the reasons.

In other words, the rubber composition of the present invention contains a modified polymer obtained by modifying styrene-butadiene rubber (A) with a nitrone compound having carboxy group (B). Thus, it is considered that carboxy groups in the nitrone-modified moiety of the carboxy-modified polymer interact with the carbon black in the composition, thereby enhancing the dispersibility of the carbon black. As a result, it is believed that the effect of carbon black improving dry grip properties strengthen.

Furthermore, it is considered that since carboxy groups in the nitrone-modified moiety of the carboxy-modified polymer interact with the carbon black in the composition, the number of crosslinking moieties is increased due to the formation of a strong bond between the rubber component and the carbon black, resulting in the exhibition of excellent rubber hardness and a high 300% modulus even under high temperatures.

The components contained and optionally contained in the rubber composition of the present invention will be described in detail below.

### Diene Rubber

The diene rubber contained in the rubber composition of the present invention contains a carboxy-modified polymer.

### Carboxy-Modified Polymer

The carboxy-modified polymer is obtained by modifying styrene-butadiene rubber (A) with a nitrone compound having carboxy group (B).

The content of the carboxy-modified polymer in the diene rubber is from 10 to 100 mass %, preferably from 50 to 90 mass %, and more preferably from 60 to 80 mass %. By keeping the content of the carboxy-modified polymer within the range described above, superior dry grip properties as well as superior rubber hardness and 300% modulus at high temperatures are realized. On the other hand, when the content of the carboxy-modified polymer is less than 10 mass %, the dry grip properties decrease along with the rubber hardness and 300% modulus at high temperatures.

### Styrene-Butadiene Rubber (A)

The carboxy-modified polymer is obtained by modifying styrene-butadiene rubber (A), as described above.

Such styrene-butadiene rubber (A) may be produced using styrene monomers and butadiene monomers.

The styrene monomer used in the production of styrene-butadiene rubber (A) is not particularly limited, with examples thereof including styrene, a-methylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethylstyrene, 4-t-butylstyrene, 5-t-butyl-2-methylstyrene, dimethylaminomethylstyrene, and dimethylaminoethylstyrene. Among these, styrene, α-methylstyrene, and 4-methylstyrene are preferred, and styrene is more preferred. Such a styrene monomer may be used alone or as a combination of two or more types.

Butadiene monomers used for the production of styrene-butadiene rubber (A) is not particularly limited, with examples thereof including 1,3-butadiene, isoprene (2-methyl-1,3-butadiene), 2,3-dimethyl-1,3-butadiene, and 2-chloro-1,3-butadiene. Among these, 1,3-butadiene or isoprene is preferred, and 1,3-butadiene is more preferred. Such a butadiene monomer may be used alone or as a combination of two or more types.

The method of producing (polymerizing) styrene-butadiene rubber (A) is not particularly limited, with examples thereof including solution polymerization and emulsion polymerization. For styrene-butadiene rubber (A), either solution-polymerized styrene-butadiene rubbers or emulsion-polymerized styrene-butadiene rubbers may be used; however, in terms of improving properties such as dry grip properties, solution-polymerized styrene-butadiene rubbers are preferably used.

The content of styrene units in styrene-butadiene rubber (A) is at least 36 mass %, preferably 36 to 50 mass %, and more preferably 36 to 40 mass %. By keeping the content of styrene units within the range described above, dry grip properties as well as rubber hardness and 300% modulus at high temperatures are enhanced. On the other hand, when the content of styrene units is less than 36 mass %, rubber hardness and 300% modulus at high temperatures lowers along with dry grip properties.

In the present invention, the styrene quantity (content of styrene units) is measured by infrared spectroscopy (the Hampton method).

In terms of properties such as handling properties, the weight average molecular weight (Mw) of styrene-butadiene rubber (A) is preferably from 100000 to 1800000 and more preferably from 300000 to 1500000. In the present specification, the weight average molecular weight (Mw) is measured by gel permeation chromatography (GPC) using tetrahydrofuran as a solvent, and calibrated using a polystyrene standard.

### Nitrone Compound Having Carboxy Group (B)

The carboxy-modified polymer of the present invention is, as described above, one modified with the nitrone compound having carboxy group (B) (hereinafter, also referred to as “carboxynitrone” or “carboxynitrone (B)”).

The carboxynitrone is not particularly limited as long as it is a nitrone having at least one carboxy group (—COOH). Nitrone herein refers to a compound having a nitrone group represented by Formula (1) below.

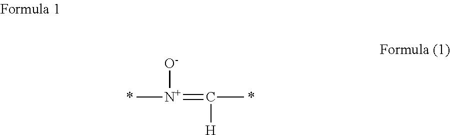

In Formula (1), * indicates a bonding position.

The carboxynitrone is preferably a compound represented by general formula (2) below.

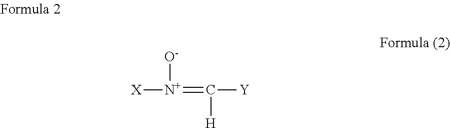

In general formula (2) above, X and Y each independently represent an aliphatic hydrocarbon group, an aromatic hydrocarbon group, or an aromatic heterocycle group that may have a substituent, provided at least one of X and Y has a carboxy group as a substituent.

Examples of aliphatic hydrocarbon groups represented by X or Y include alkyl groups, cycloalkyl groups, alkenyl groups, and the like. Examples of alkyl groups include a methyl group, ethyl group, n-propyl group, isopropyl group, n-butyl group, isobutyl group, sec-butyl group, tert-butyl group, n-pentyl group, isopentyl group, neopentyl group, tert-pentyl group, 1-methylbutyl group, 2-methylbutyl group, 1,2-dimethylpropyl group, n-hexyl group, n-heptyl group, n-octyl group, and the like. Among these, alkyl groups having from 1 to 18 carbons are preferable, with alkyl groups having from 1 to 6 carbons being more preferable. Examples of cycloalkyl groups include a cyclopropyl group, cyclobutyl group, cyclopentyl group, cyclohexyl group, and the like. Among these, cycloalkyl groups having from 3 to 10 carbons are preferable, with cycloalkyl groups having from 3 to 6 carbons being more preferable. Examples of alkenyl groups include a vinyl group, 1-propenyl group, allyl group, isopropenyl group, 1-butenyl group, 2-butenyl group, and the like. Among these, alkenyl groups having from 2 to 18 carbons are preferable, with alkenyl groups having from 2 to 6 carbons being more preferable.

Examples of aromatic hydrocarbon groups represented by X or Y include aryl groups, aralkyl groups, and the like.

Examples of aryl groups include a phenyl group, naphthyl group, anthryl group, phenanthryl group, biphenyl group, and the like. Among these, aryl groups having from 6 to 14 carbons are preferable, aryl groups having from 6 to 10 carbons are more preferable, and a phenyl group and a naphthyl group are even more preferable.

Examples of aralkyl groups include a benzyl group, phenethyl group, phenylpropyl group, and the like. Among these, aralkyl groups having from 7 to 13 carbons are preferable, aralkyl groups having from 7 to 11 carbons are more preferable, and benzyl groups are even more preferable.

Examples of aromatic heterocyclic groups represented by X or Y include a pyrrolyl group, furyl group, thienyl group, pyrazolyl group, imidazolyl group (imidazole group), oxazolyl group, isooxazolyl group, thiazolyl group, isothiazolyl group, pyridyl group (pyridine group), furan group, thiophene group, pyridazinyl group, pyrimidinyl group, pyrazinyl group, and the like. Among these, a pyridyl group is preferable.

The groups represented by X and Y may have substituents other than a carboxy group (hereinafter, also referred to as “other substituents”) as long as at least one of X and Y has a carboxy group as a substituent, as described above.

Other substituents of the group represented by X or Y are not particularly limited, with examples thereof including alkyl groups having from 1 to 4 carbons, hydroxy groups, amino groups, nitro groups, sulfonyl groups, alkoxy groups, halogen atoms, and the like.

Note that exemplary aromatic hydrocarbon groups having such a substituent include aryl groups with a substituent, such as a tolyl group and xylyl group; and aralkyl groups with a substituent, such as a methylbenzyl group, ethylbenzyl group, and methylphenethyl group.

The compound represented by general formula (2) above is preferably a compound represented by general formula (b) below.

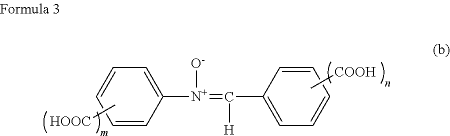

In general formula (b), m and n each independently represent an integer from 0 to 5, with the sum of m and n being 1 or greater.

The integer represented by m is preferably an integer from 0 to 2, and more preferably an integer of 0 or 1, because the solubility in a solvent during carboxynitrone synthesis is better, making synthesis easier.

The integer represented by n is preferably an integer from 0 to 2, and more preferably an integer of 0 or 1, because the solubility in a solvent during carboxynitrone synthesis is better, making synthesis easier.

Furthermore, the sum of m and n (m+n) is preferably from 1 to 4, and more preferably 1 or 2.

The carboxynitrone represented by general formula (b) is not particularly limited but is preferably a compound selected from the group consisting of N-phenyl-α-(4-carboxyphenyl)nitrone represented by Formula (b1) below, N-phenyl-α-(3-carboxyphenyl)nitrone represented by Formula (b2) below, N-phenyl-α-(2-carboxyphenyl)nitrone represented by Formula (b3) below, N-(4-carboxyphenyl)-α-phenylnitrone represented by Formula (b4) below, N-(3-carboxyphenyl)-α-phenylnitrone represented by Formula (b5) below, and N-(2-carboxyphenyl)-α-phenylnitrone represented by Formula (b6) below.

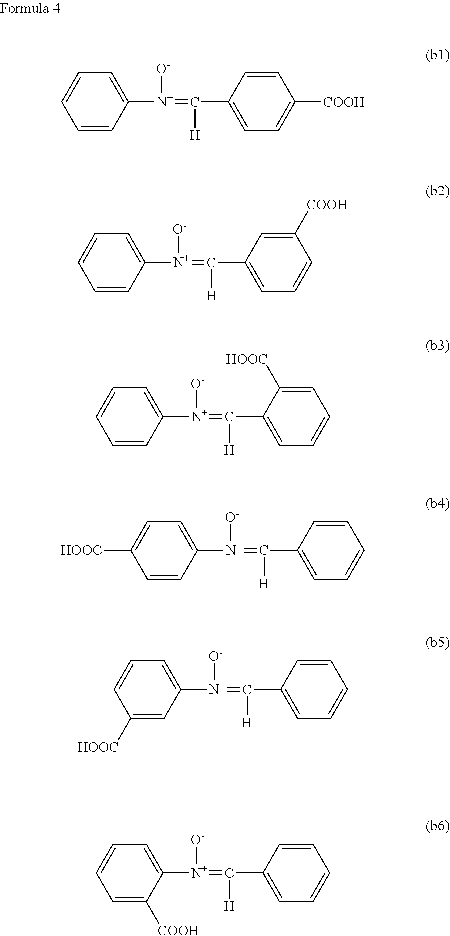 [SMILES: O=C(O)c1ccc(/C=[N+](\[O-])c2ccccc2)cc1 ; O=C(O)c1cccc(/C=[N+](\[O-])c2ccccc2)c1 ; O=C(O)c1ccccc1/C=[N+](\[O-])c1ccccc1 ; O=C(O)c1ccc(/[N+]([O-])=C/c2ccccc2)cc1 ; O=C(O)c1cccc(/[N+]([O-])=C/c2ccccc2)c1 ; O=C(O)c1ccccc1/[N+]([O-])=C/c1ccccc1]

The method of synthesizing the carboxynitrone is not particularly limited, with conventionally known methods capable of being used. For example, a compound (carboxynitrone) having a carboxy group and a nitrone group can be obtained by stirring a compound having a hydroxyamino group (—NHOH) and a compound having an aldehyde group (—CHO) and a carboxy group at a molar ratio of hydroxyamino group to aldehyde group (—NHOH/—CHO) of 1.0 to 1.5 in the presence of an organic solvent (for example methanol, ethanol, tetrahydrofuran, and the like) at room temperature for 1 to 24 hours to allow both groups to react.

### Method for Producing a Carboxy-Modified Polymer

The carboxy-modified polymer of the present invention is obtained by modifying styrene-butadiene rubber (A) with a nitrone compound having carboxy group (B), as described above.

The reaction mechanism in producing the carboxy-modified polymer is one in which carboxynitrone (B) is reacted against the double bonds of styrene-butadiene rubber (A). The method of producing the carboxy-modified polymer (carboxynitrone-modified SBR) is not particularly limited, with examples thereof including a method in which styrene-butadiene rubber (A) and carboxynitrone (B) are blended together for 1 to 30 minutes at from 100 to 200° C.

When blended as such, a cycloaddition reaction occurs between the double bond of the butadiene contained in styrene-butadiene rubber (A) and the nitrone group in carboxynitrone (B), forming a five-membered ring as illustrated in Formula (4-1) and Formula (4-2) below. Note that Formula (4-1) below represents a reaction between a 1,4-bond and a nitrone group, while Formula (4-2) below represents a reaction between a 1,2-vinyl bond and a nitrone group. While formulas (4-1) and (4-2) illustrate the reactions for the case in which the butadiene is 1,3-butadiene, the same reaction leads to the formation of a five-membered ring even for the case in which the butadiene is other than 1,3-butadiene.

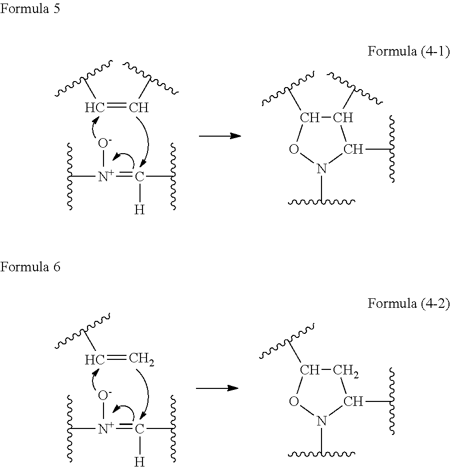

The content of carboxynitrone (B) used for modifying styrene-butadiene rubber (A) to synthesize the carboxy-modified polymer (hereinafter, also referred to as a “converted CPN amount”) is preferably from 0.1 to 10 parts by mass and preferably from 0.3 to 3 parts by mass per 100 parts by mass of the diene rubber. By keeping the converted CPN amount within the range described above, the deforming stress at high temperatures tends to increase.

For example, if 35 parts by mass of the carboxy-modified polymer is contained per 100 parts by mass of the diene rubber and the carboxy-modified polymer is obtained via the reaction between 100 parts by mass of SBR and 1 part by mass of carboxynitrone, 0.35 parts by mass (=35×(1/101)) of carboxynitrone (B) is used for synthesis of the carboxy-modified polymer, which is 35 parts by mass. Thus, the converted CPN amount is 0.35 parts by mass.

Regarding synthesis of the carboxy-modified polymer, while the charged amount (added amount) of carboxynitrone (B) is not particularly limited, it is preferably from 0.1 to 20 parts by mass and more preferably from 1 to 5 parts by mass per 100 parts by mass of styrene-butadiene rubber (A).

### Degree of Modification

The degree of modification of the carboxy-modified polymer is preferably from 0.02 to 4.0 mol % and more preferably from 0.10 to 2.0 mol %. The lower limit value of the degree of modification is preferably at least 0.20 mol %.

The “degree of modification” herein refers to the proportion (mol %) of the double bonds modified with carboxynitrone (B) relative to all double bonds attributed to butadiene (butadiene units) in styrene-butadiene rubber (A). For example, if the butadiene is 1,3-butadiene, the “degree of modification” refers to the proportion (mol %) of the structure represented by Formula (4-1) above or Formula (4-2) above formed by modification with carboxynitrone. The degree of modification, for example, can be found by NMR measurements of the SBRs before and after modification.

Note that in this specification, a carboxy-modified polymer having a degree of modification of 100 mol % falls under the category of a diene rubber.

### Other Diene Rubbers

The abovementioned diene rubber may contain other rubber components besides the carboxy-modified polymer (hereinafter, also referred to as “other diene rubbers”). Such other diene rubbers are not particularly limited, with examples thereof including a natural rubber (NR), an isoprene rubber (IR), a butadiene rubber (BR), an aromatic vinyl-conjugated diene copolymer rubber (e.g., an unmodified SBR (styrene-butadiene rubber) and an SBR modified with a modifier other than the nitrone compound having carboxy group (B)), an acrylonitrile-butadiene copolymer rubber (NBR), a butyl rubber (IIR), a halogenated butyl rubber (Br-IIR, Cl-IIR), and a chloroprene rubber (CR). Among these, an unmodified SBR is preferably used. Preferred aspects of such an unmodified SBR are the same as those of styrene-butadiene rubber (A) described above.

### Carbon Black

The rubber composition of the present invention contains carbon black.

The carbon black content is from 80 to 150 parts by mass, and preferably from 90 to 140 parts by mass per 100 parts by mass of the diene rubber. By keeping the carbon black content within the range described above, the tire tread is allowed to quickly reach a high-temperature state (e.g., approximately 100° C.), thereby demonstrating good dry grip properties. On the other hand, if the carbon black content is less than the range described above, the dry grip properties lower. Moreover, if the carbon black content exceeds the range above, the wear resistance may lower or the mechanical properties at high temperatures (rubber hardness or 300% modulus) may decrease.

While the nitrogen adsorption specific surface area (N₂SA) of carbon black is not particularly limited, it is preferably from 150 to 400 m²/g, more preferably from 200 to 400 m²/g, and even more preferably from 250 to 390 m²/g.

Note that the nitrogen adsorption specific surface area (N₂SA) is the value of the amount of nitrogen adsorbed to the surface of carbon black, measured in accordance with JIS K6217-2:2001 (Part 2: Determination of specific surface area—Nitrogen adsorption methods—Single-point procedures).

### Optional Components

The rubber composition of the present invention may contain a terpene resin. As the terpene resin, aromatic modified terpene resins are preferably used in terms of further improving the dry grip properties.

In terms of further improving the dry grip properties, the content of the aromatic modified terpene resin, if contained, is preferably from 10 to 50 parts by mass, and more preferably from 20 to 45 parts by mass per 100 parts by mass of the diene rubber.

The aromatic modified terpene resin is obtained by polymerizing a terpene and an aromatic compound. Examples of terpenes include α-pinene, β-pinene, dipentene, limonene, and the like. Examples of aromatic compounds include styrene, α-methylstyrene, vinyl toluene, indene, and the like. Among these, styrene-modified terpene resins are preferable as the aromatic modified terpene resin.

The rubber composition of the present invention may contain cyclic polysulfides as a vulcanizing agent. Regarding the cyclic polysulfide, in terms of further improving rubber hardness and 300% modulus at high temperatures or improving wear resistance, cyclic polysulfides represented by the following general formula (s) are preferably used.

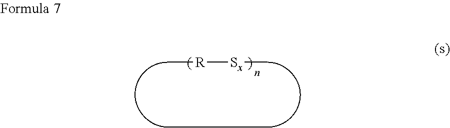

In the above formula (s), R represents substituted or unsubstituted alkylene groups having from 4 to 8 carbons, substituted or unsubstituted oxyalkylene groups having from 4 to 8 carbons (“—R₁—O—”, wherein R₁ represents alkylene groups having from 4 to 8 carbons), or —R₂—O—R₃— (R₂ and R₃ each independently represent alkylene groups having from 1 to 7 carbons). In addition, x is a number from 3 to 5, on average. In addition, n is an integer from 1 to 5.

In Formula (s), R preferably has from 4 to 8 carbons, more preferably from 4 to 7 carbons.

Examples of substituents for R in Formula (s) include a phenyl group, benzyl group, methyl group, epoxy group, isocyanate group, vinyl group, silyl group, and the like.

Note that S in Formula (s) above represents sulfur.

X is a number from 3 to 5, on average, and preferably a number from 3.5 to 4.5, on average.

N is an integer from 1 to 5, preferably an integer from 1 to 4.

The cyclic polysulfide represented by general formula (s) can be produced by ordinary methods, for example, the production method described in JP-A-2007-92086.

The rubber composition of the present invention may further contain additives as necessary within a scope that does not inhibit the effect or purpose thereof.

Examples of additives include various additives typically used in rubber compositions, such as fillers other than carbon black (e.g., silica), silane coupling agents, zinc oxide (zinc white), stearic acid, resins for adhesion, peptizing agents, anti-aging agents, waxes, processing aids, aroma oils, liquid polymers, terpene resins other than aromatic terpene resin, thermosetting resins, vulcanizing agents other than cyclic polysulfide (e.g., sulfur), and vulcanization accelerators.

### Production Method of the Rubber Composition for Tire Treads

The method of producing the rubber composition of the present invention is not particularly limited, with specific examples thereof including a method whereby each of the abovementioned components is kneaded using a publicly known method and device (e.g., Banbury mixer, kneader, roller, and the like). If the rubber composition of the present invention contains sulfur or a vulcanization accelerator, the components other than sulfur and the vulcanization accelerator are preferably blended first at high temperatures (preferably from 80 to 140° C.) and then cooled before sulfur or the vulcanization accelerator is blended.

In addition, the rubber composition of the present invention can be vulcanized or crosslinked under conventional, publicly known vulcanizing or crosslinking conditions.

### Application

The rubber composition of the present invention is used in the production of pneumatic tires. Above all, it is suitably used for the tire tread of pneumatic tires (preferably, pneumatic tires for racing (for competition)).

### Pneumatic Tire

The pneumatic tire of the present invention is a pneumatic tire produced using the rubber composition of the present invention described above in the tire treads.

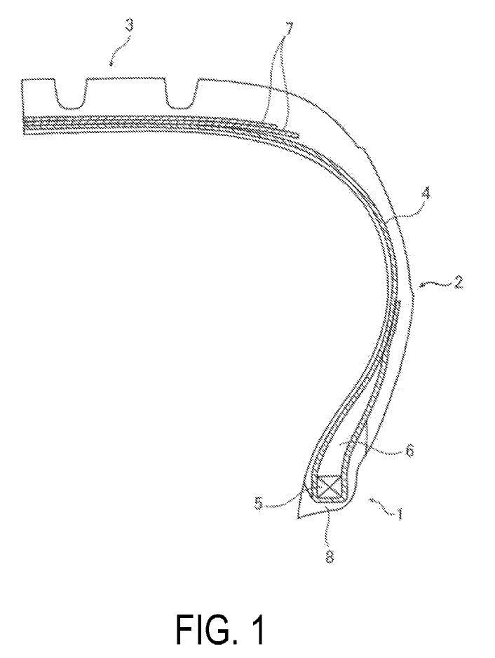

FIG. 1 is a partial cross-sectional schematic view of a tire illustrating one embodiment of a pneumatic tire of the present invention; however, the pneumatic tire of the present invention is not limited to the mode illustrated in FIG. 1.

In FIG. 1, the number 1 denotes a bead portion, the number 2 denotes a sidewall portion, and the number 3 denotes a tire tread portion.

Carcass layer 4, in which fiber cords are embedded, is disposed extending between a left-right pair of bead portions 1, while the ends of carcass layer 4 wind upwards around bead cores 5 and bead fillers 6 from the inner side to the outer side of the tire.

In tire tread portion 3, belt layer 7 is provided along the entire periphery of the tire on the outer side of carcass layer 4.

Rim cushions 8 are provided in parts of bead portion 1 that are in contact with the rim.

Note that tire tread portion 3 is formed of the rubber composition of the present invention described above.

The pneumatic tire of the present invention can be produced, for example, in accordance with conventionally known methods. In addition to ordinary air or air with adjusted oxygen partial pressure, inert gases such as nitrogen, argon, and helium can be used as the gas with which the tire is filled.

Since the pneumatic tire of the present invention is superior in dry grip properties as well as rubber hardness and 300% modulus at high temperatures, it is suitable for racing tires (tires for competition), and particularly for racing tires used for dry road surfaces.

### EXAMPLES

Embodiments of the present invention are described in further detail below. However, the present invention is in no way limited to these examples.

### Synthesis of Carboxynitrone

Ethanol heated to 40° C. (900 mL) was filled in a 2 L eggplant-shaped flask, then terephthalaldehydic acid represented by Formula (b-1) below (30.0 g) was added and dissolved. To this solution, a solution in which phenylhydroxylamine represented by Formula (a-1) below (21.8 g) was dissolved in methanol (100 mL) was added and stirred at room temperature for 19 hours. Upon completion of stirring, a nitrone compound (carboxynitrone; 41.7 g) represented by Formula (c-1) below was obtained by recrystallization from methanol. The yield was 86%.

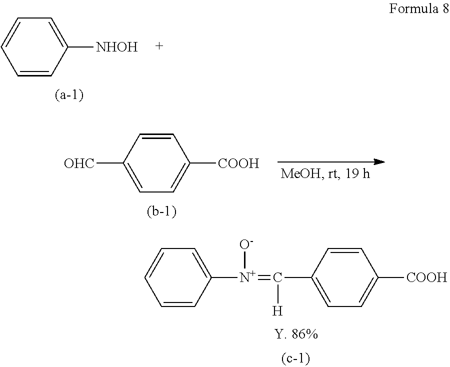

### Synthesis of Diphenylnitrone

Benzaldehyde represented by Formula (b-2) below (42.45 g) and ethanol (10 mL) were placed in a 300 mL eggplant-shaped flask, then a solution in which phenylhydroxylamine represented by Formula (a-1) below (43.65 g) was dissolved in ethanol (70 mL) was added and stirred at room temperature for 22 hours. Upon completion of stirring, diphenylnitrone (65.40 g) represented by Formula (c-2) below was obtained as white crystals by recrystallization from ethanol. The yield was 83%.

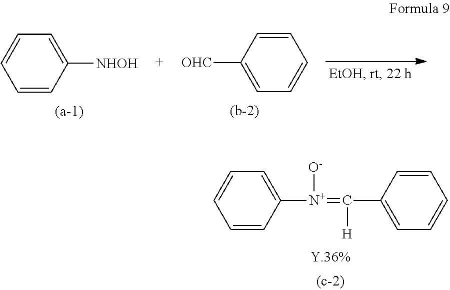

### Synthesis of Carboxynitrone-Modified SBR (Modified SBR 1)

SBR (Tafuden E581, manufactured by Asahi Kasei Chemicals Corporation) was loaded in a Bunbury mixer at 120° C. and masticated for 2 minutes. Subsequently, 1 part by mass of the carboxynitrone synthesized as above was added per 100 parts by mass of the SBR and mixed at 160° C. for 5 minutes to modify the SBR with the carboxynitrone. The carboxynitrone-modified SBR thus obtained is referred to as modified SBR 1.

Note that the SBR used (Tafuden E581 manufactured by Asahi Kasei Chemicals Corporation) corresponds to “S-SBR 2” described below, and the content of styrene units (styrene quantity) is 37 mass %.

NMR analysis conducted on the obtained modified SBR 1 to determine the degree of modification revealed a degree of modification of the modified SBR 1 of 0.21 mol %. Specifically, the degree of modification was determined as described below. Namely, the SBRs before and after modification were measured for the peak area at around 8.08 ppm (assigned to the two protons adjacent the carboxy group) via ¹H-NMR (CDCl₃, 400 MHz, TMS) using CDCl₃ as a solvent to find the degree of modification. Note that the ¹H-NMR analysis of the modified SBR 1 was conducted using samples obtained by dissolving the modified SBR 1 in toluene, twice conducting purification by methanol precipitation, and then drying under reduced pressure.

### Synthesis of Diphenylnitrone-Modified SBR (Modified SBR 2)

SBR (Tafuden E581 manufactured by Asahi Kasei Chemicals Corporation) was loaded in a Bunbury mixer at 120° C. and masticated for 2 minutes. Subsequently, 1 part by mass of the diphenylnitrone synthesized as above was added per 100 parts by mass of the SBR and mixed at 160° C. for 5 minutes to modify the SBR with diphenylnitrone. The diphenylnitrone-modified SBR thus obtained is referred to as modified SBR 2.

Note that the SBR used (Tafuden E581 manufactured by Asahi Kasei Chemicals Corporation) corresponds to “S-SBR 2” described below, and the content of styrene units (styrene quantity) is 37 mass %.

NMR analysis conducted on the obtained modified SBR 2 to determine the degree of modification revealed a degree of modification of the modified SBR 2 of 0.23 mol %. The method of determining the degree of modification is as described above.

### Preparation of Rubber Composition for Tire Treads

The components shown in Table 1 below were blended in the proportions (parts by mass) shown in Table 1 below.

Specifically, the components shown in Table 1 below except for sulfur and the vulcanization accelerator were first mixed in a Bunbury mixer at a temperature of 80° C. for 5 minutes. Thereafter, a roll was used to mix sulfur and the vulcanization accelerator to obtain each rubber composition for tire treads (hereinafter, “rubber composition for tire treads” is also referred to as “rubber composition”).

### Manufacture of Vulcanized Rubber Sheet

A vulcanized rubber sheet was produced by press-vulcanizing each of the obtained (unvulcanized) rubber compositions for 15 minutes at 160° C. in a mold (15 cm×15 cm×0.2 cm).

### Evaluation of Rubber Hardness

In accordance with JIS K6253, a type A durometer was used to measure the rubber hardness for each of the obtained vulcanized rubber sheets at a temperature of 100° C. The results are shown in Table 1 (rubber hardness). The results are shown as index values, relative to the value of Comparative Example 1 expressed as 100. Higher index values can be assessed as indicating that rubber hardness is high and mechanical characteristics are superior, and that steering stability and grip performance are excellent when the pneumatic tire travels at high speed for a long time.

### Evaluation of Dry Grip Properties

The loss tangent tan δ (20° C.) was measured for each obtained vulcanized rubber sheet using a viscoelastic spectrometer (manufactured by Toyo Seiki Seisaku-sho, Ltd.) under the following conditions: 10% initial distortion, ±2% amplitude, 20 Hz frequency, and temperature of 20° C. The results are shown in Table 1 (dry grip properties). The results are shown as index values, relative to the tan δ (20° C.) of Comparative Example 1 expressed as 100. Larger values of tan δ (20° C.) can be assessed as indicating superior dry grip properties when formed into a tire.

### Evaluation of 300% Modulus

A JIS no. 3 dumbbell-shaped test piece was punched out from each obtained vulcanized rubber sheet, and tensile testing was conducted at a tensile test speed of 500 mm/min in accordance with JIS K 6251. The 300% modulus (M₃₀₀) was measured at a temperature of 100° C. The results are shown in Table 1 (300% modulus). The results are shown as index values, relative to the 300% modulus of Comparative Example 1 expressed as 100. Larger index values can be assessed as indicating that tensile strength at break and rigidity in a high-temperature state are high and mechanical characteristics are superior, and that steering stability, grip performance and wear resistance are excellent when formed into a tire.

In Table 1, the converted nitrone amount indicates the amount in terms of parts by mass of the nitrone compound used in the synthesis of the modified polymer (modified SBR 1 or modified SBR 2) relative to 100 parts by mass of the diene rubber. Note that for the case in which carboxynitrone is used for the modification, the converted nitrone amount has the same meaning as that of the converted CPN amount.

In addition, the degree of modification represents the degree of modification of the modified polymer (the modified SBR 1 or modified SBR 2) described above. The modification efficiency indicates the proportion of nitrone compound used for the reaction, relative to the charged amount of the nitrone compound.

Moreover, in Table 1, numerical values regarding S-SBR 1, S-SBR 2, modified SBR 1, and modified SBR 2 represent the content containing oil (parts by mass), while numerical values in parentheses represent the content of the rubber component (parts by mass).

TABLE 1

| | | Comparative | Comparative | Comparative | | | |
|---|---|---|---|---|---|---|---|
| Table 1 | | Example 1 | Example 2 | Example 3 | Example 1 | Example 2 | Example 3 |
| Diene rubber | S-SBR1 | 50.00 | 50.00 | 50.00 | 50.00 | 50.00 | 50.00 |
| | | (36.36) | (36.36) | (36.36) | (36.36) | (36.36) | (36.36) |
| | S-SBR2 | 87.5 | 43.75 | | 43.75 | | 73.40 |
| | | (63.64) | (31.82) | | (31.82) | | (53.37) |
| | Modified SBR 1 | | | | 43.75 | 87.5 | 14.10 |
| | (carboxynitrone-modified SBR) | | | | (31.82) | (63.64) | (10.27) |
| | Modified SBR 2 | | 43.75 | 87.5 | | | |
| | (diphenylnitrone-modified SBR) | | (31.82) | (63.64) | | | |
| Carbon black | | 120.00 | 120.00 | 120.00 | 120.00 | 120.00 | 120.00 |
| Other components | Stearic acid | 2.00 | 2.00 | 2.00 | 2.00 | 2.00 | 2.00 |
| | Terpene resin | 20.00 | 20.00 | 20.00 | 20.00 | 20.00 | 20.00 |
| | Oil | 60.00 | 60.00 | 60.00 | 60.00 | 60.00 | 60.00 |
| | Zinc oxide | 3.00 | 3.00 | 3.00 | 3.00 | 3.00 | 3.00 |
| | Sulfur | 2.00 | 2.00 | 2.00 | 2.00 | 2.00 | 2.00 |
| | Vulcanization accelerator | 2.00 | 2.00 | 2.00 | 2.00 | 2.00 | 2.00 |
| Characteristics | Converted nitrone amount | | 0.31 | 0.63 | 0.31 | 0.63 | 0.10 |
| of modified | Modification efficiency | | 82% | 82% | 76% | 76% | 76% |
| polymer | Degree of modification in | | 0.23 | 0.23 | 0.21 | 0.21 | 0.21 |
| | modified polymer (mol %) | | | | | | |
| Evaluation | Rubber hardness (100° C.) | 100 | 96 | 97 | 101 | 100 | 100 |
| Results | Dry grip properties (tan δ | 100 | 99 | 100 | 101 | 103 | 101 |
| | (20° C.)) | | | | | | |
| | 300% modulus (100° C.) | 100 | 92 | 95 | 109 | 117 | 104 |

The details of each component shown in Table 1 above are as follows.
S-SBR 1: Solution-polymerized styrene-butadiene rubber; styrene quantity of 36 mass %; weight average molecular weight (Mw) of 1470000; Tg of −13° C.; oil extended product comprising 37.5 parts by mass of oil per 100 parts by mass of the rubber component; Tafuden E680 (manufactured by Asahi Kasei Chemicals Corporation)
S-SBR 2: Solution-polymerized styrene-butadiene rubber; styrene quantity of 37 mass %; weight average molecular weight (Mw) of 1260000; Tg of −27° C.; oil extended product comprising 37.5 parts by mass of oil per 100 parts by mass of the rubber component; Tafuden E581 (manufactured by Asahi Kasei Chemicals Corporation)
modified SBR 1: modified SBR 1 synthesized as described above (carboxynitrone-modified SBR), oil extended product comprising 37.5 parts by mass of oil per 100 parts by mass of the rubber component
modified SBR 2: modified SBR 2 synthesized as described above (diphenylnitrone-modified SBR), oil extended product comprising 37.5 parts by mass of oil per 100 parts by mass of the rubber component
Carbon black: nitrogen adsorption specific surface area of 225 m²/g; Toka Black #5500 (manufactured by Tokai Carbon Co., Ltd.)
Stearic acid: Stearic acid YR (manufactured by NOF Corporation)
Terpene resin: YS RESIN 10125 (manufactured by Yasuhara Chemical Co., Ltd.)
Oil: Extract No. 4S (manufactured by Showa Shell Sekiyu K.K.)
Zinc oxide: Zinc Oxide III (manufactured by Seido Chemical Industry Co., Ltd.)
Sulfur: oil treatment sulfur (manufactured by Karuizawa Refinery Ltd.)
Vulcanization accelerator: NOCCELER CZ-G (manufactured by Ouchi Shinko Chemical Industrial Co., Ltd.)

As can be seen in Table 1, Examples 1 to 3, which contain the carboxynitrone-modified SBR, were all superior in dry grip properties as well as rubber hardness and 300% modulus at high temperatures.

Moreover, in the comparison between Example 1 and 2, it was shown that the 300% modulus at high temperatures got better when using those having a content of at least 50 mass % of the carboxynitrone-modified SBR in the diene rubber (Example 2).

On the other hand, Comparative Example 2, which does not contain the carboxynitrone-modified SBR, but rather the diphenylnitrone-modified SBR, had poor dry grip properties as well as rubber hardness and 300% modulus at high temperatures.

Comparative Example 3, which does not contain the carboxynitrone-modified SBR, but rather the diphenylnitrone-modified SBR, also had insufficient rubber hardness and 300% modulus at high temperatures.

### REFERENCE SIGNS LIST

1 Bead portion
2 Sidewall portion
3 Tire tread portion
4 Carcass layer
5 Bead core
6 Bead filler
7 Belt layer
8 Rim cushion

1. A rubber composition for tire treads containing carbon black and a diene rubber comprising a carboxy-modified polymer, wherein:
the carbon black content is from 80 to 150 parts by mass per 100 parts by mass of the diene rubber;
the carboxy-modified polymer is obtained by modifying styrene-butadiene rubber (A) with a nitrone compound having carboxy group (B), the content of the carboxy-modified polymer in the diene rubber being from 10 to 100 mass %;
the content of styrene units in styrene-butadiene rubber (A) is at least 36 mass %; and
when the degree of modification refers to the proportion (mol %) of double bonds modified with the nitrone compound having carboxy group (B) relative to all double bonds attributed to butadiene in styrene-butadiene rubber (A), the degree of modification of the carboxy-modified polymer is from 0.02 to 4.0 mol %.

2. The rubber composition for tire treads according to claim 1, wherein the nitrone compound having carboxy group (B) is a compound selected from the group consisting of N-phenyl-α-(4-carboxyphenyl)nitrone, N-phenyl-α-(3-carboxyphenyl)nitrone, N-phenyl-α-(2-carboxyphenyl)nitrone, N-(4-carboxyphenyl)-α-phenylnitrone, N-(3-carboxyphenyl)-α-phenylnitrone, and N-(2-carboxyphenyl)-α-phenylnitrone.

3. The rubber composition for tire treads according to claim 1, wherein the nitrogen adsorption specific surface area of carbon black is from 150 to 400 m²/g.

4. The rubber composition for tire treads according to claim 1, wherein the amount of the nitrone compound having carboxy group (B) used to modify styrene-butadiene rubber (A) is from 0.1 to 10 parts by mass per 100 parts by mass of the diene rubber.

5. A pneumatic tire comprising a tire tread formed using the rubber composition for tire treads according to claim 1.

6. The rubber composition for tire treads according to claim 2, wherein the nitrogen adsorption specific surface area of carbon black is from 150 to 400 m²/g.

7. The rubber composition for tire treads according to claim 2, wherein the amount of the nitrone compound having carboxy group (B) used to modify styrene-butadiene rubber (A) is from 0.1 to 10 parts by mass per 100 parts by mass of the diene rubber.

8. The rubber composition for tire treads according to claim 3, wherein the amount of the nitrone compound having carboxy group (B) used to modify styrene-butadiene rubber (A) is from 0.1 to 10 parts by mass per 100 parts by mass of the diene rubber.

9. The rubber composition for tire treads according to claim 6, wherein the amount of the nitrone compound having carboxy group (B) used to modify styrene-butadiene rubber (A) is from 0.1 to 10 parts by mass per 100 parts by mass of the diene rubber.

10. A pneumatic tire comprising a tire tread formed using the rubber composition for tire treads according to claim 2.

11. A pneumatic tire comprising a tire tread formed using the rubber composition for tire treads according to claim 3.

12. A pneumatic tire comprising a tire tread formed using the rubber composition for tire treads according to claim 4.

13. A pneumatic tire comprising a tire tread formed using the rubber composition for tire treads according to claim 6.

14. A pneumatic tire comprising a tire tread formed using the rubber composition for tire treads according to claim 7.

15. A pneumatic tire comprising a tire tread formed using the rubber composition for tire treads according to claim 8.

16. A pneumatic tire comprising a tire tread formed using the rubber composition for tire treads according to claim 9.
